(19) United States
(12) Patent Application Publication
(10) Pub. No.: US 2021/0379533 A1
(43) Pub. Date: Dec. 9, 2021

(54) WATER PURIFIER

(71) Applicant: WOONGJIN COWAY Co., Ltd., Gongju-si (KR)

(72) Inventors: Hyoung-Min MOON, Seoul (KR); Chul-Ho KIM, Seoul (KR); Hyun-Seok MOON, Seoul (KR); Byung-Sun MO, Seoul (KR); Hyun-Soo SHIN, Seoul (KR); Sang-Hyeon KANG, Seoul (KR)

(73) Assignee: WOONGJIN COWAY Co., Ltd., Gongju-si (KR)

(21) Appl. No.: 17/287,782

(22) PCT Filed: Sep. 10, 2019
(86) PCT No.: PCT/KR2019/011680

§ 371 Date: Apr. 22, 2021

(30) Foreign Application Priority Data
Oct. 24, 2018 (KR) 10-2018-0127371

(51) Int. Cl. B01D 61/12; B01D 61/02; C02F 1/44; C02F 1/00

(52) U.S. Cl. CPC B01D 61/12; B01D 61/025; C02F 1/441; C02F 1/008; B01D 2311/103; C02F 2209/02; B01D 2311/14; C02F 2201/005; B01D 2313/18; B01D 2313/243; C02F 2209/03; B01D 2311/106

(57) ABSTRACT

A water purifier includes a filtering part including a reverse osmosis filter for filtering water and a discharge part for discharging, to the outside, purified water filtered in the filtering part. The filtering part further includes a pump provided in front of the reverse osmosis filter so as to supply the water to the reverse osmosis filter, and a supply valve that opens and closes so as to supply the water from a water supply source to the filtering part. The supply valve can be provided between the pump and the reverse osmosis filter.

### TECHNICAL FIELD

The present disclosure relates to a water purifier filtering water and supplying filtered water to users.

### BACKGROUND ART

Water purifiers filter water and supply filtered water to users.

The water purifier includes a reverse osmosis (RO) filter including an RO membrane to filter water, and in order to supply water to the RO filter at a predetermined filtration pressure or higher, the water purifier may include a pump before the RO filter.

When water is supplied to the RO filter by means of a pump as described above, vibrations may be transmitted to the RO filter by water hammering, which may damage the RO filter or other components of the water purifier.

### DISCLOSURE

### Technical Problem

The present disclosure has been made upon recognition of at least one of demands or problems occurring in the related art as described above.

An aspect of the present disclosure is to minimize vibrations transmitted to a reverse osmosis (RO) filter due to water hammering when water is supplied to the RO filter.

Another aspect of the object of the present disclosure is to minimize an occurrence of problems such as damage to components of a water purifier such as an RO filter or the like due to vibrations based on water hammering.

### Technical Solution

According to an aspect of the present disclosure, a water purifier related to an exemplary embodiment for realizing at least one of the above tasks may include the following features.

A water purifier according to an exemplary embodiment in the present disclosure includes: a filtering part including a reverse osmosis (RO) filter filtering water; and a discharge part externally discharging purified water filtered by the filtering part, wherein the filtering part further includes a pump provided in front of the RO filter and supplying water to the RO filter and a supply valve opened and closed so that water is supplied to the filtering part from a water source, wherein the supply valve is provided between the pump and the RO filter.

In this case, the pump may be directly connected to the water source.

A water purifier according to another exemplary embodiment in the present disclosure includes: a filtering part including a reverse osmosis (RO) filter filtering water; and a discharge part externally discharging purified water filtered by the filtering part, wherein the filtering part further includes a pump provided in front of the RO filter and supplying water to the RO filter, and a vibration buffer tank is provided between the pump and the RO filter to buffer vibrations due to water hammering.

A water purifier according to another exemplary embodiment in the present disclosure includes: a filtering part including a reverse osmosis (RO) filter filtering water; and a discharge part externally discharging purified water filtered by the filtering part, wherein the filtering part further includes a pump provided in front of the RO filter and supplying water to the RO filter and a pressure sensor measuring pressure of water supplied from a water source to the filtering part, wherein the water purifier further includes: a controller electrically connected to the pressure sensor and the pump, wherein the controller may drive the pump when pressure of water supplied from the water source to the filtering part, measured by the pressure sensor, is lower than a preset pressure, may not drive the pump when the pressure is equal to or higher than the preset pressure, and may reduce power of the pump according to pressure of water supplied to the filtering part.

A water purifier according to another exemplary embodiment in the present disclosure includes: a filtering part including a reverse osmosis (RO) filter filtering water; and a discharge part externally discharging purified water filtered by the filtering part, wherein the filtering part further includes a pump provided in front of the RO filter and supplying water to the RO filter, wherein the water purifier may further include: a controller electrically connected to the pump, wherein the controller may not drive the pump or may reduce power of the pump for a preset time or upon receiving a user instruction.

Meanwhile, the discharge part may include a purified water line in which purified water filtered by the filtering part flows, a discharge line connected to the outside, and a drain line connected to the discharge line, and purified water is drained through the drain line for a predetermined period of time and subsequently discharged through the discharge line so as to be supplied to a user.

In this case, a flow path switching valve may be provided at a portion where the discharge line and the drain line are connected, or a discharge valve may be provided at the discharge line and a drain valve may be provided on the drain line.

In addition, a purified water supply valve may be provided in the purified water line.

A hot purified water line may be connected to a portion of the purified water line before the purified water supply valve and to the discharge line, and a hot purified water supply valve and a water heater heating purified water to produce hot purified water may be provided at the hot purified water line.

The hot purified water may be drained through the drain line until a temperature of hot purified water discharged from the water heater reaches a predetermined temperature, and when the temperature of the hot purified water discharged from the water heater reaches the predetermined temperature, hot purified water may be externally discharged through the discharge line so as to be supplied to the user.

A cold purified water line may be connected to a portion of the purified water line before the purified water supply valve and to the discharge line, and a cold purified water supply valve and a water cooler cooling purified water to produce cold purified water may be provided at the cold purified water line.

### Advantageous Effects

As described above, according to an exemplary embodiment in the present disclosure, when water is supplied to the RO filter, vibrations transmitted to the RO filter due to water hammering may be minimized.

In addition, according to an exemplary embodiment in the present disclosure, damage to components of the water purifier such as the RO filter or the like due to vibrations based on water hammering may be minimized.

### DESCRIPTION OF DRAWINGS

FIG. 1 is a view illustrating a first exemplary embodiment of a water purifier according to the present disclosure.

FIGS. 2 through 7 are views illustrating an operation of the first exemplary embodiment of the water purifier according to the present disclosure.

FIG. 8 is a view illustrating a second exemplary embodiment of the water purifier according to the present disclosure.

FIG. 9 is a view illustrating a third exemplary embodiment of the water purifier according to the present disclosure.

FIG. 10 is a view illustrating a fourth exemplary embodiment of the water purifier according to the present disclosure.

### MODE FOR INVENTION

In order to help understand the features of the present disclosure as described above, a water purifier related to an exemplary embodiment in the present disclosure will be described in detail hereinafter.

The exemplary embodiments described below will be described on the basis of exemplary embodiments most suitable for understanding the technical features of the present disclosure, and the technical features of the present disclosure are not limited by the described exemplary embodiments and it is illustrated that the present disclosure is realized as in the exemplary embodiments described hereinafter. Therefore, the present disclosure may be variously modified within the technical scope of the present disclosure through the exemplary embodiments described below, and such modifications will fall within the technical scope of the present disclosure. Also, in order to help understand the exemplary embodiments described below, related components, among components performing the same operations in each exemplary embodiment, are denoted by the same or like reference numerals.

### First Exemplary Embodiment of Water Purifier

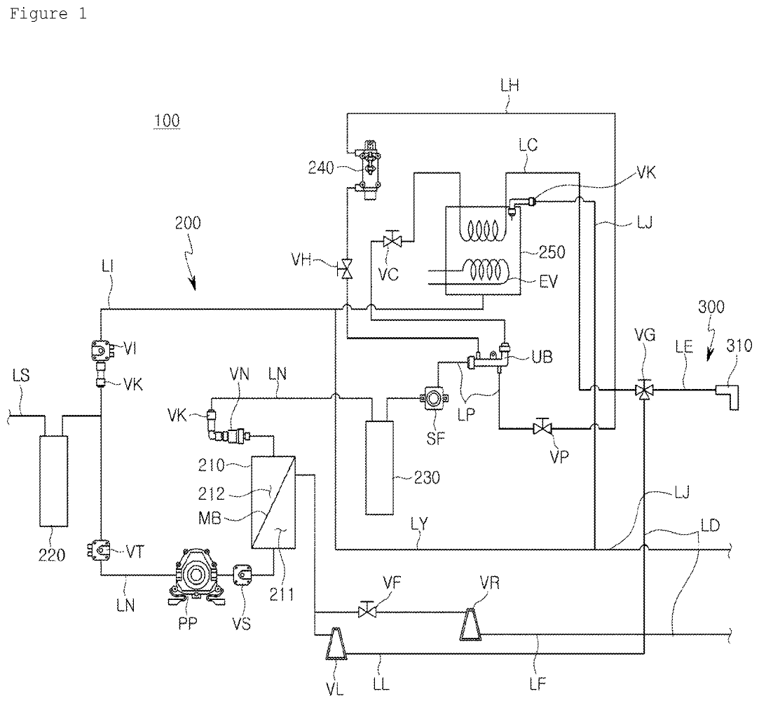

Hereinafter, a first exemplary embodiment of a water purifier according to the present disclosure will be described with reference to FIGS. 1 through 7.

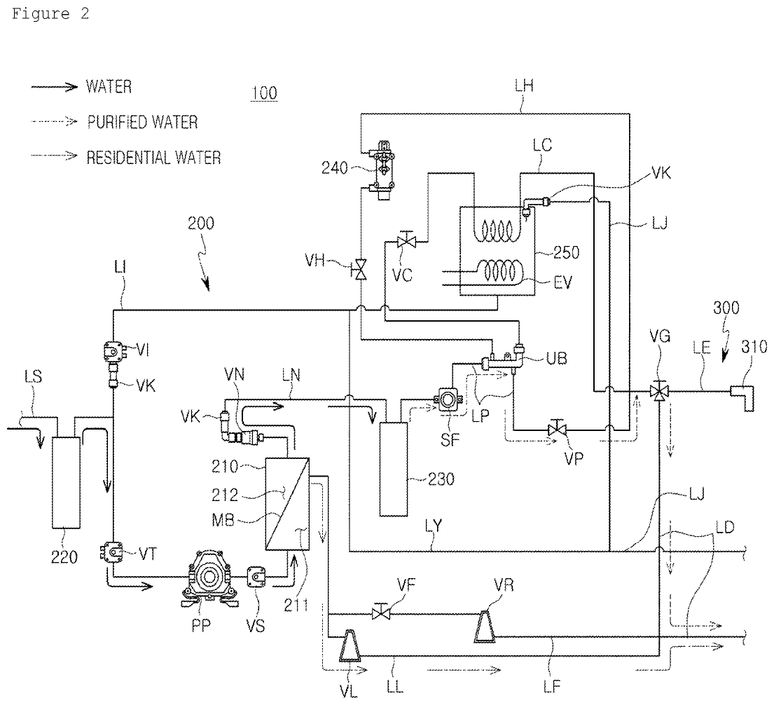

FIG. 1 is a view illustrating a first exemplary embodiment of a water purifier according to the present disclosure, and FIGS. 2 to 7 are views illustrating an operation of the first exemplary embodiment of a water purifier according to the present disclosure.

The first exemplary embodiment of the water purifier 100 according to the present disclosure may include a filtering part 200 and a discharge part 300.

The filtering part 200 may include a reverse osmosis (RO) filter 210 that filters water. The RO filter 210 may include an RO membrane MB as shown in FIG. 1 to divide the RO filter 210 into a non-filtering side 211 and a filtering side 212. Connection lines LN may be connected to the non-filtering side 211 and the filtering side 212 of the RO filter 210, respectively. In addition, a residential water line LL may be further connected to the non-filtering side 211 of the RO filter 210.

As shown in FIGS. 2 to 6, water supplied from a water source (not shown) such as tap water introduced through a connection line LN may flow into the non-filtering side 211 of the RO filter 210. Part of the water flowing into the non-filtering side 211 of the RO filter 210 may be filtered while passing through the RO membrane MB, and the remaining water may not pass through the RO membrane MB. Water filtered while passing through the RO membrane MB may flow to the filtering side 212 and then be discharged through a connection line LN connected to the filtering side 212. Water that has not passed through the RO membrane MB, that is, residential water, may be drained through a residential water line LL connected to the non-filtering side 211. For example, residential water may be drained through a drain line LD to which the residential water line LL is connected.

The connection line LN connected to the filtering side 212 of the RO filter 210 may have a pressure reducing valve VN and a check valve VK. Accordingly, pressure of water filtered by the RO filter 210 may be reduced to a preset pressure by the pressure reducing valve VN, and water filtered by the RO filter 210 may not return to the RO filter 210 by the check valve VK.

The residential water line LL may have a residential water valve VL. Residential water may be drained as filtering pressure of the RO filter 210 is formed on the non-filtering side 211 of the RO filter 210 by the residential water valve VL.

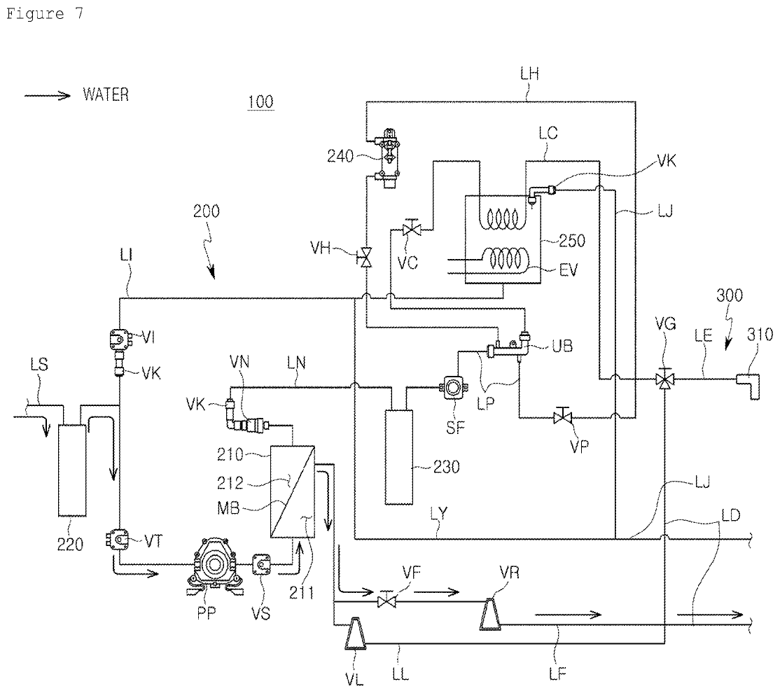

Meanwhile, a flushing line LF may be connected to a portion of the residential water line LL, e.g., the residential water line LL before the residential water valve VL. A flushing valve VF may be provided in the flushing line LF. When the flushing valve VF is opened, as shown in FIG. 7, water flowing into the non-filtering side 211 of the RO filter 210 may flush the RO membrane MB and may be drained together with foreign substances attached to the RO membrane MB through the flushing line LF. For example, water including foreign substances attached to the RO membrane MB by flushing the RO membrane MB may be drained through the drain line LD to which the flushing line LF is connected.

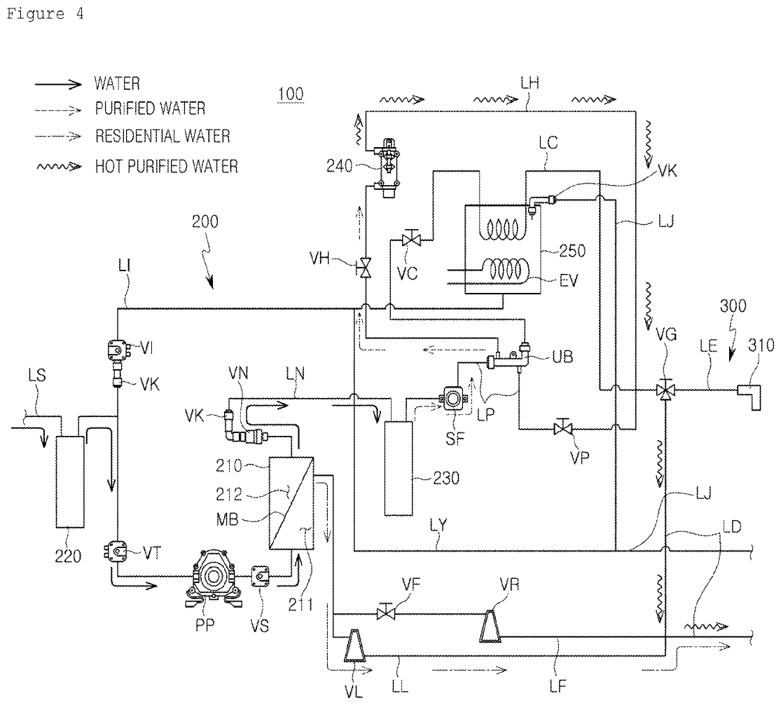

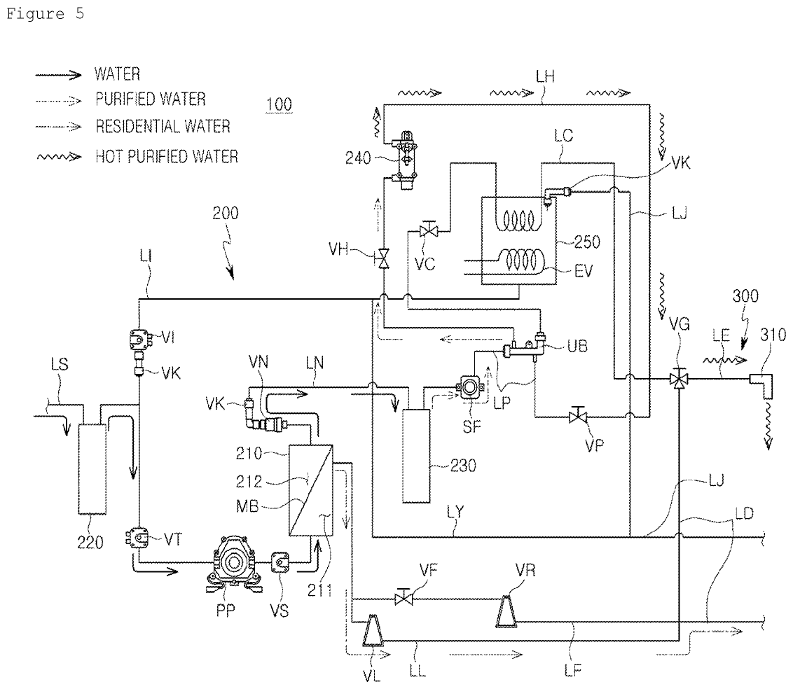

In addition, the flushing valve VF may be opened when hot purified water is discharged externally through the discharge line LE and the discharge member 310 (to be described later) included in the discharge part 300 as shown in FIG. 5 or when the hot purified water is drained externally through the drain line LD (to be described later) included in the discharge part 300 as shown in FIG. 4. The hot purified water may be discharged or drained at a flow rate less than that of purified water or cold purified water to be described later. Accordingly, more load may be applied to a pump PP included in the filtering part 200 when hot purified water is discharged or drained than when purified water or cold purified water is discharged through the discharge line LE and the discharge member 310 of the discharge part 300 or than when purified water is drained through the drain line LD of the discharge part 300. Therefore, when hot purified water is discharged externally through the discharge line LE and the discharge member 310 of the discharge part 300 or when hot purified water is drained through the drain line LD of the discharge part 300, opening of the flushing valve VF may reduce the load applied to the pump PP because residential water may be discharged even through the flushing line LF, as well as through the residential water line LL.

A resistance valve VR may be provided in the flushing line LF, e.g., a portion of the flushing line LF after the flushing valve VF. Accordingly, since residential water is discharged even through the flushing line LF to reduce the load applied to the pump PP when hot water is discharged or drained as described above, residential water may not be excessively discharged through the flushing line LF.

The filtering part 200 may further include the pump PP. The pump PP may be provided in front of the RO filter 210. The pump PP may be provided in, for example, a connection line LN connected to the non-filtering side 211 of the RO filter 210. The pump PP may supply water to the RO filter 210, for example, by pressure above a filtration pressure of the RO filter 210. The pump PP may not be actuated for flushing of the RO membrane MB of the RO filter 210 as shown in FIG. 7. Accordingly, the RO membrane MB of the RO filter 210 may be flushed by water supply pressure of the water source.

The filtering part 200 may further include a pre-treatment filter 220 and a post-treatment filter 230.

The pre-treatment filter 220 may be connected to the water source by a supply line LS as shown in FIG. 1.

In addition, the pre-treatment filter 220 may be connected to the connection line LN connected to the non-filtering side 211 of the RO filter 210. Accordingly, as shown in FIGS. 2 to 6, water from the water source may be filtered first by the pre-treatment filter 220 and then by the RO filter 210.

As shown in FIG. 1, the post-treatment filter 230 may be connected to a connection line LN connected to the filtering side 212 of the RO filter 210. In addition, the post-treatment filter 230 may be connected to a purified water line LP. Accordingly, as shown in FIGS. 2 through 6, water filtered by the RO filter 210 may be filtered by the post-treatment filter 230 and then flow through the purified water line LP.

A water filter included in addition to the RO filter 210 in the filtering part 200 may be any water filter as long as it can filter water and the number of water filters may not be limited. However, only the RO filter 210 may be included in the filtering part 200.

As illustrated in FIG. 1, a supply valve VS may be provided in a connection line LN connecting the pre-treatment filter 220 and the RO filter 210, for example, in a portion of the connection line LN between the pump PP and the RO filter 210. Accordingly, when the supply valve VS is opened, water from the water source may be first filtered by the pre-treatment filter 220 as shown in FIGS. 2 to 7. In this state, when the pump PP is actuated, water filtered by the pre-filter 220 is sequentially filtered by the RO filter 210 and the post-treatment filter 230 and subsequently flow through the purified water line LP as shown in FIGS. 2 through 6. If the pump PP is not actuated, as described above and as shown in FIG. 7, water filtered by the pre-treatment filter 220 may flow into the non-filtering side 211 of the RO filter 210 to flush the RO membrane MB and subsequently flow a portion of the residential water line LL and the flushing line LF.

As shown in FIG. 1, a shutoff valve VT may be provided in a portion of the connection line LN before the pump PP. The shutoff valve VT may be a normal open valve which is open when not operated and is closed when operated. For example, the shutoff valve VT may be open when electricity is not applied and may be closed when electricity is applied. Accordingly, in a normal time when the operation is not performed because electricity is not applied, the shut-off valve VT may be open. In the event of an accident such as power failure or failure of the pump PP, electricity may be applied to the shut-off valve VT from an emergency power source (not shown) so that the shut-off valve VT may operate to be closed. Accordingly, in the event of an accident or failure, water from the water source may be blocked from flowing into the filtering part 200 by the shutoff valve VT.

The purified water line LP may have a purified water supply valve VP. When the purified water supply valve VP is opened, purified water filtered by the filtering part 200 may flow to the discharge part 300, e.g., the discharge line LE (to be described later) included in the discharge part 300. The purified water line LP may have a flow sensor SF. Accordingly, it is possible to measure a flow rate of purified water filtered by the filtering part 200 and flowing through the purified water line LP. As shown in FIG. 1, the flow sensor SF may be provided in a portion of the purified water line LP between, for example, the post-treatment filter 230 and a branch unit UB (to be described later) provided in a portion of the purified water line LP before the purified water supply valve VP. However, the portion of the purified water line LP in which the flow sensor SF is provided may not be limited and the flow sensor SF may be provided in any portion of the purified water line LP as long as a flow rate of purified water flowing through the purified water line LP after being filtered by the filtering part 200 can be measured at the portion.

A hot purified water line LH may be connected to a portion of the purified water line LP before the water supply valve VP. For example, as shown in FIG. 1, the branch unit UB may be provided in a portion of the purified water line LP before the water supply valve VP, and the hot purified water line LH may be connected to the branch unit UB.

The hot purified water line LH may have a hot purified water supply valve VH and a water heater 240. When the hot purified water supply valve VH is opened, purified water filtered by the filtering part 200 may flow to the hot purified water line LH through the purified water line LP as shown in FIGS. 4 and 5. In addition, purified water flowing through the hot purified water line LH may flow into the water heater 240. The purified water flowing into the water heater 240 may be heated by the water heater 240 to become hot purified water. A configuration of the water heater 240 is not particularly limited, and any known configuration may be used as long as it is a configuration in which the purified water flowing into the water heater 240 is heated to make hot purified water. The hot purified water supply valve VH may be, for example, a flow control valve. Accordingly, the hot purified water supply valve VH may adjust a flow rate of purified water supplied to the water heater 240. For example, the hot purified water supply valve VH may adjust the flow rate of purified water supplied to the water heater 240 so that purified water supplied to the water heater 240 is heated to become hot purified water having a predetermined temperature within a predetermined time. Accordingly, a flow rate at which hot purified water is discharged or drained externally may be less than a flow rate at which purified water is discharged or drained externally or a flow rate at which cold purified water is discharged externally.

The hot purified water line LH may be connected to the discharge line LE of the discharge part 300. Accordingly, hot purified water produced by the water heater 240 may flow to the discharge line LE as shown in FIGS. 4 and 5.

A cold purified water line LC may be connected to a portion of the purified water line LP before the purified water supply valve VP. For example, as shown in FIG. 1, the cold purified water line LC may be connected to the aforementioned branch unit UB provided in a portion of the water line LP before the water supply valve VP.

The cold purified water line LC may have a cold water supply valve VC and a water cooler 250. Water before being filtered by the RO filter 210 may be supplied to the water cooler 250 and stored as iced water and cooled. In addition, as shown in FIG. 1, at least a portion of the cold purified water line LC passes through the water cooler 250, so that purified water flowing through the cold purified water line LC may be cooled by the iced water of the water cooler 250.

For example, as shown in FIG. 1, the iced water supply line LI having an iced water supply valve VI may be connected to the connection line LN connected to the RO filter 210 before the RO filter 210, for example, the connection line LN connected to the non-filtering side 211 of the RO filter 210, and the water cooler 250. Accordingly, when the iced water supply valve VI is opened, water before being filtered by the RO filter 210, for example, water filtered by the pre-treatment filter 220, is supplied to the water cooler 250 through the iced water supply line LI and stored in the water cooler 250. A check valve VK may be provided in the iced water supply line LI before the iced water supply valve VI. Accordingly, water flowing through the iced water supply line LI may be prevented from flowing to a portion before the RO filter 210, for example, backward to the pre-treatment filter 220.

An air discharge line LJ may be connected to the water cooler 250 as shown in FIG. 1. Accordingly, when water before being filtered by the RO filter 210 is supplied to the water cooler 250 as iced water, air contained in the water cooler 250 may be discharged externally through the air discharge line LJ. A check valve VK may be provided in the air discharge line LJ. Accordingly, air discharged from the water cooler 250 may not return to the water cooler 250.

In addition, an iced water drain line LY may be connected to a portion of the iced water supply line LI between the iced water supply valve VI and the water cooler 250. The opposite side of the iced water drain line LY connected to the iced water supply line LI may be blocked by a stopper (not shown) or the like. And, when it is necessary to drain iced water of the water cooler 250 externally, the stopper stopping the iced water drain line LY may be opened so that iced water of the water cooler 250 may be drained through the iced water drain line LY.

The water cooler 250 may include a cooling unit to cool the iced water stored in the water cooler 250. The cooling unit provided in the water cooler 250 may be, for example, an evaporator EV through which a refrigerant flows, as shown in FIG. 1. However, the cooling unit provided in the water cooler 250 is not particularly limited, and any known unit such as a thermoelectric module (not shown) including a thermoelectric element (not shown), etc. may be used as long as it can cool iced water of the water cooler 250.

The cold purified water line LC may be connected to the discharge line LE of the discharge part 300. Accordingly, the cold purified water produced in the water cooler 250 may flow to the discharge line LE as shown in FIG. 7.

Meanwhile, when water is supplied to the RO filter 210, vibrations transmitted to the RO filter 210 due to water hammering may be minimized.

To this end, as shown in FIG. 1, the supply valve VS allowing water from the water source to be supplied to the filtering part 200 may be provided between the pump PP and the RO filter 210. That is, the supply valve VS may be provided at a portion of the connection line LN between the pump PP and the RO filter 210.

The supply valve VS is a typical component of the water purifier 100 capable of reducing water pressure. Therefore, if the supply valve VS is provided before the pump PP, water pressure is reduced by the supply valve VS before the pump PP, so that when water is supplied to the RO filter 210 by the pump PP, a pressure difference before and after the pump PP is significant, causing relatively large water hammering. In addition, vibrations caused by water hammering may be transmitted to the RO filter 210.

However, in the first exemplary embodiment of the water purifier 100 according to the present disclosure, since the supply valve VS is provided between the pump PP and the RO filter 210 as described above, water pressure may not be reduced by the supply valve VS before the pump PP. Accordingly, when water is supplied to the RO filter 210 by the pump PP, water hammering may be minimized, so that transmission of vibrations to the RO filter 210 due to water hammering may be minimized. Therefore, it is possible to minimize the occurrence of problems that the components of the water purifier 100, such as the RO filter 210, are damaged by vibrations due to water hammering.

The discharge part 300 may discharge the purified water filtered by the filtering part 200 externally. The discharge part 300 may include a discharge line LE and a drain line LD connected to the discharge line LE.

The discharge line LE may be connected to the aforementioned purified water line LP through which the purified water filtered by the filtering part 200 flows and to the outside. The discharge line LE may be connected to the discharge member 310 connected to the outside so as to be connected to the outside, for example, as shown in FIG. 1. In addition, the discharge line LE may also be connected to the aforementioned hot purified water line LH or cold purified water line LC.

Meanwhile, if filtering is not performed by the filtering part 200 for a long time, the water filter such as the RO filter 210 or the connection line LN or the purified water line LP, etc. in which purified water is produced and flows may be contaminated by foreign substances or bacteria. Therefore, purified water filtered by the filtering part 200 and supplied to a user after a long period of time during which filtering is not performed may be contaminated by foreign substances or bacteria. Therefore, in a case in which filtering is not performed for a long period of time in the filtering part 200, the water filter such as the RO filter 210 or the connection line LN or the purified water line LP, etc. in which purified water is produced and flows needs to be flushed to supply uncontaminated purified water to the user.

In addition, when the water purifier 100 is first installed in a consumer's location, air present in the water filter such as the RO filter 210 or the connection line LN or the purified water line LP, etc. in which purified water is produced and flows needs to be discharged before the water puffier 100 is first used.

In the first exemplary embodiment of the water purifier 100 according to the present disclosure, after purified water is drained through the drain line LD for a predetermined period of time as shown in FIG. 2, purified water may be externally dispensed through the discharge line LE and supplied to the user.

Accordingly, in a case in which filtering is not performed for a long period of time in the filtering part 200, purified water is externally drained through the drain line LD for a predetermined period of time and then externally discharged through the discharge line LE so as to be supplied to the user. Accordingly, purified water may be supplied to the user after the water filter such as the RO filter 210 or the connection line LN or the purified water line LP, etc. in which purified water is produced and flows is flushed for a predetermined period of time. Also, even in a case in which filtering is not performed for a long period of time in the filtering part 200, uncontaminated purified water may be provided to the user.

In addition, when the water purifier 100 is first installed in a location of a consumer, purified water may be drained through the drain line LD for a predetermined period of time before the water purifier 100 is first used, and thereafter, purified water may be discharged through the discharge line LE so as to be supplied to the user. Accordingly, air present in the water filter such as the RO filter 210 or the connection line LN or the purified water line LP, etc. in which purified water is produced and flows may be easily discharged.

In addition, in the first exemplary embodiment of the water purifier 100 according to the present disclosure, hot purified water is drained through the drain line LD until a temperature of the hot purified water discharged from the water heater 240 reaches a predetermined temperature as shown in FIG. 4, and when the temperature of the hot purified water discharged from the water heater 240 reaches the predetermined temperature, the hot purified water may be externally discharged through the discharge line LE so as to be supplied to the user as shown in FIG. 5.

To this end, as shown in FIG. 1, a flow path switching valve VG may be provided at a portion to which the discharge line LE and the drain line LD are connected. However, a discharge valve (not shown) may be provided in the discharge line LE, and a drain valve (not shown) may be provided in the drain line LD.

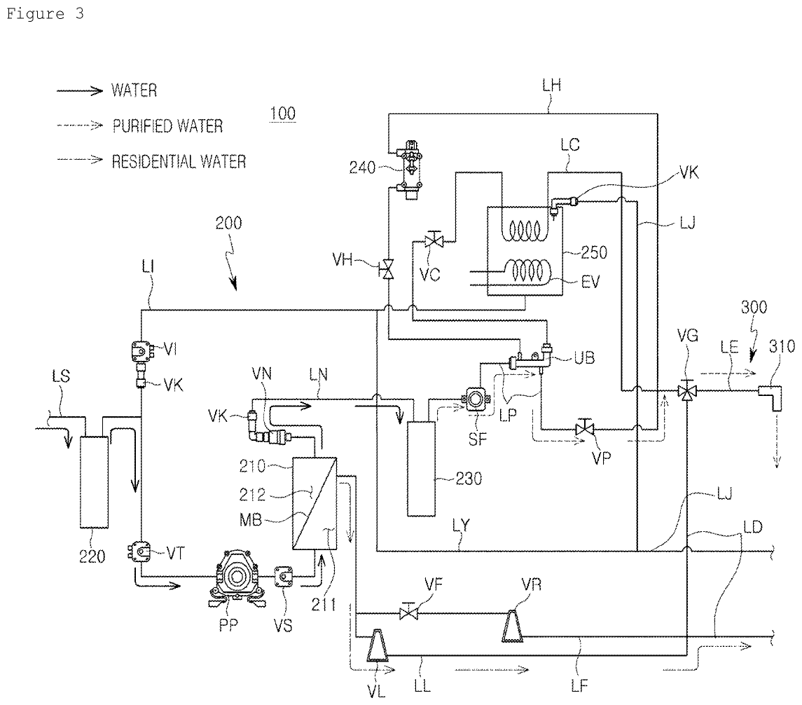

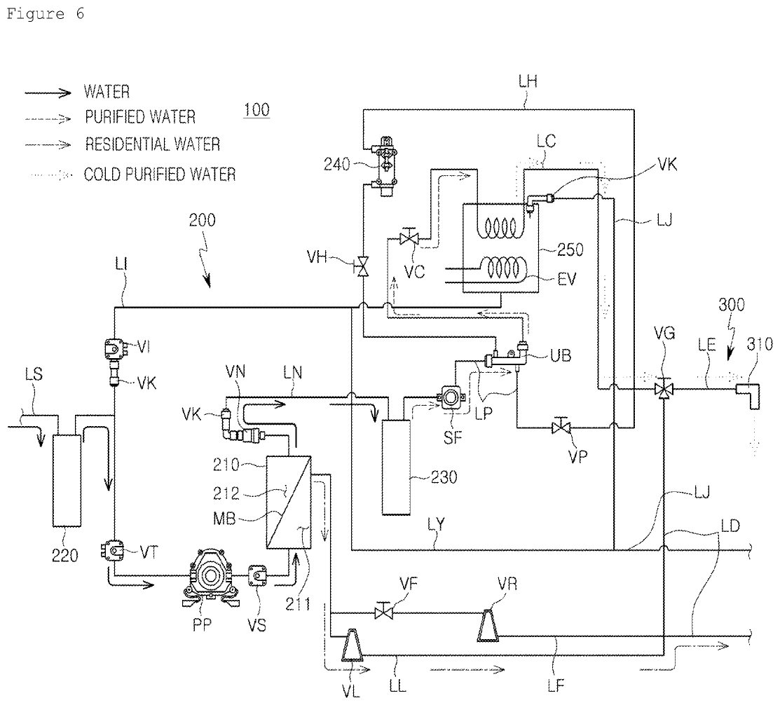

When the flow path switching valve VG switches a flow path to the outside, e.g., the discharge member 310, purified water may be externally discharged through the discharge member 310 as shown in FIG. 3 or hot purified water may be externally discharged through the discharge member 310 as shown in FIG. 5. In addition, when the flow path switching valve VG switches the flow path to the outside, e.g., the discharge member 310, cold purified water may be externally discharged through the discharge member 310 as shown in FIG. 6.

When the flow path switching valve VG switches the flow path to the drain line LD, purified water may be drained through the drain line LD as shown in FIG. 2 or hot purified water may be drained through the drain line LD as shown in FIG. 4.

### Second Exemplary Embodiment of Water Purifier

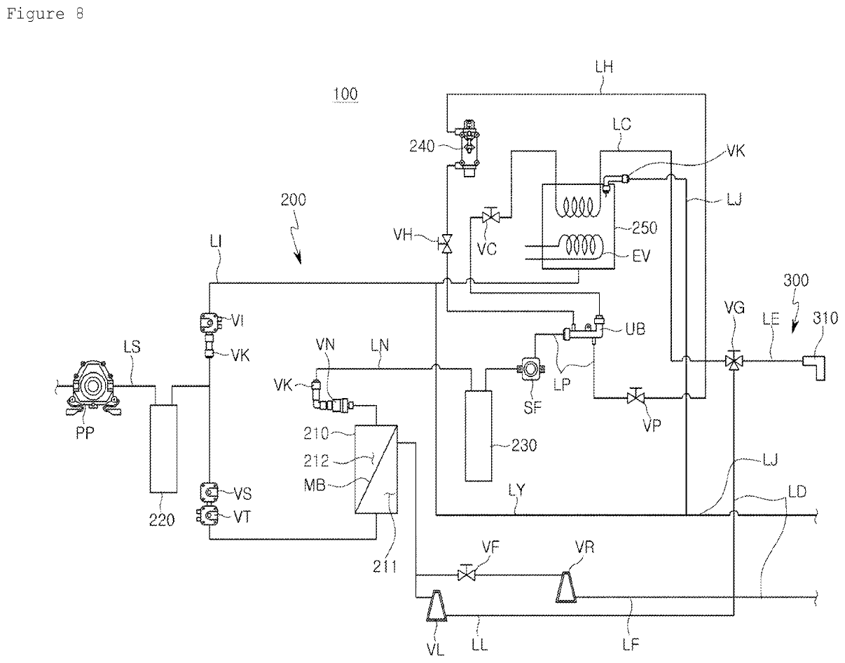

Hereinafter, a second exemplary embodiment of a water purifier according to the present disclosure will be described with reference to FIG. 8.

FIG. 8 is a view illustrating a second exemplary embodiment of a water purifier according to the present disclosure.

Here, in the second exemplary embodiment of the water purifier according to the present disclosure, the pump PP is directly connected to a water source and a component for reducing pressure of water is provided between a pump PP and an RO filter 210 in the water purifier 100, so that vibrations transmitted to the RO filter 210 due to water hammering when water is supplied to the RO filter 210 is minimized, compared with the first exemplary embodiment of the water purifier according to the present disclosure described above with reference to FIGS. 1 through 7.

Thus, the different configuration will be mainly described hereinafter and descriptions of other components may be replaced by the descriptions above with reference to FIGS. 1 through 7.

In the second exemplary embodiment of the water purifier according to the present disclosure, the pump PP may be directly connected to a water source, and a component for reducing water pressure may be provided between the pump PP and the RO filter 210. For example, as shown in FIG. 8, the pump PP may be provided in the supply line LS connected to the water source and may be directly connected to the water source. Also, a component of the water purifier 100 for reducing water pressure such as the pre-treatment filter 220, the supply valve VS, or the shutoff valve VT may be provided between the pump PP and the RO filter 210 as shown in FIG. 1.

Accordingly, a reduction of water pressure before the pump PP may be minimized, water hammering may be minimized when water is supplied to the RO filter 210 by the pump PP, and transmission of vibrations due to water hammering to the RO filter 210 may be minimized.

### Third Exemplary Embodiment of Water Purifier

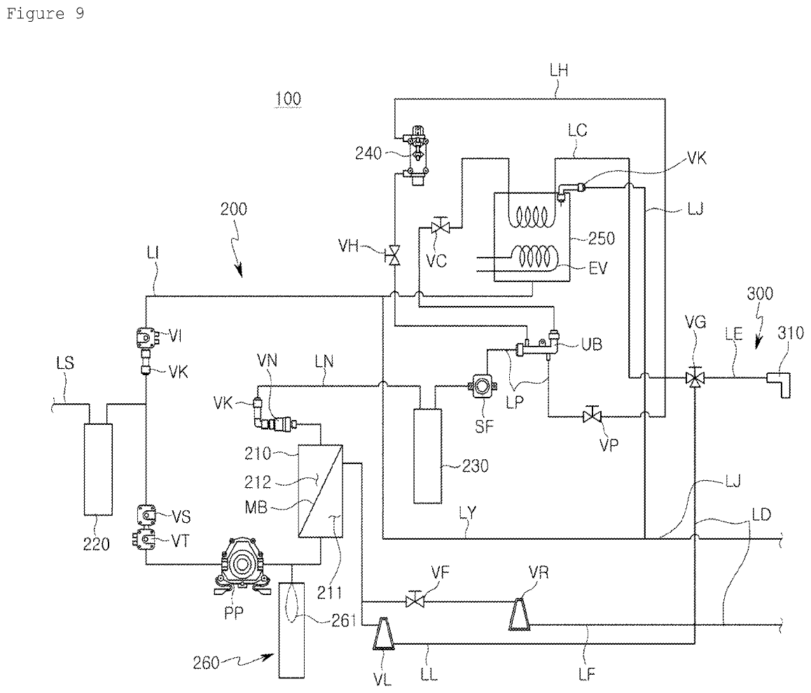

Hereinafter, a third exemplary embodiment of a water purifier according to the present disclosure will be described with reference to FIG. 9.

FIG. 9 is a view illustrating a third exemplary embodiment of a water purifier according to the present disclosure.

Here, in the third exemplary embodiment of the water purifier according to the present disclosure, a vibration buffer tank 260 is provided between the pump PP and the RO filter 210 to buffer vibrations due to water hammering, so that vibrations transmitted to the RO filter 210 due to water hammering when water is supplied to the RO filter 210 is minimized, compared with the first exemplary embodiment of the water purifier according to the present disclosure described above with reference to FIGS. 1 through 7.

Thus, the different configuration will be mainly described hereinafter and descriptions of other components may be replaced by the descriptions above with reference to FIGS. 1 through 7.

In the third exemplary embodiment of the water purifier according to the present disclosure, the vibration buffer tank 260 may provided between the pump PP and the RO filter 210. Accordingly, the vibrations caused by water hammering may be buffered by the vibration buffer tank 260, so that transmission of vibrations to the RO filter 210 due to water hammering may be minimized.

For example, as shown in FIG. 9, the vibration buffer tank 260 may be connected to a portion of the connection line LN between the pump PP and the RO filter 210. In addition, the vibration buffer tank 260 may be filled with air and may include an expansion and contraction member 261 connected to the connection line LN and allowing water to enter or exit and expanding or contracting according to pressure of water. However, the configuration of the vibration buffer tank 260 is not particularly limited, and any known configuration such as a surge tank may be used as long as it can buffer vibrations due to water hammering.

### Fourth Exemplary Embodiment of Water Purifier

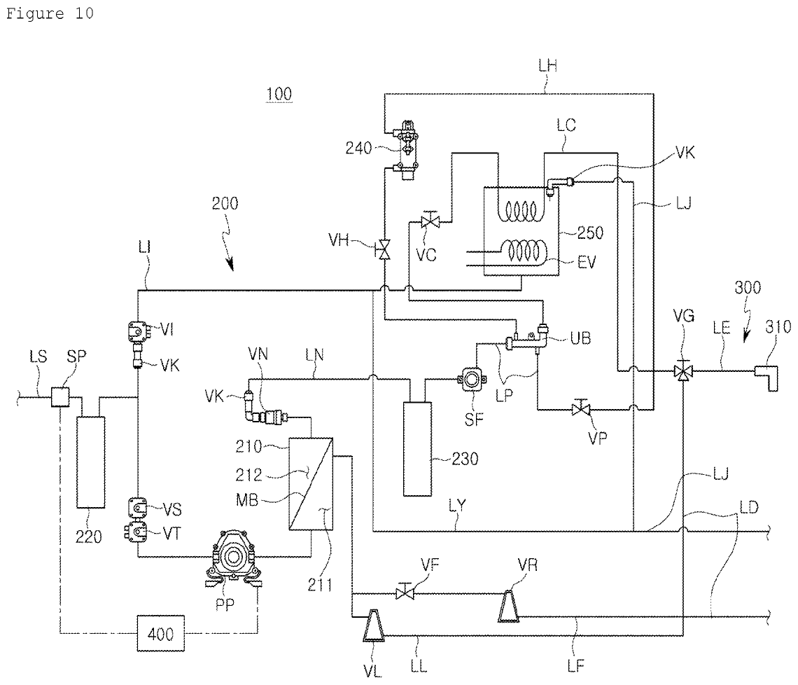

Hereinafter, a fourth exemplary embodiment of a water purifier according to the present disclosure will be described with reference to FIG. 10.

FIG. 10 is a view illustrating a fourth exemplary embodiment of a water purifier according to the present disclosure.

Here, the fourth exemplary embodiment of a water purifier according to the present disclosure further includes a controller 400 electrically connected to the pump PP and the controller 400 may not drive the pump PP or reduce power of the pump PP under a predetermined condition to minimize vibrations transmitted to the RO filter 210 due to water hammering when water is supplied to the RO filter 210, compared with the first exemplary embodiment of the water purifier according to the present disclosure described above with reference to FIGS. 1 through 7.

Thus, the different configuration will be mainly described hereinafter and descriptions of other components may be replaced by the descriptions above with reference to FIGS. 1 through 7.

The fourth exemplary embodiment of the water purifier according to the present disclosure may further include the controller 400 electrically connected to the pump PP. In addition, the controller 400 may not drive the pump PP or may reduce power of the pump PP under a predetermined condition.

For example, the filtering part 200 may include a pressure sensor (SP) that measures pressure of water supplied to the filtering part 200 from a water source and is electrically connected to the controller 400. As shown in FIG. 10, for example, the pressure sensor SP may be provided in the supply line LS and measure pressure of water supplied to the filtering part 200 from the water source. The configuration of the pressure sensor SP is not particularly limited and any known configuration may be used as long as it can measure pressure of water supplied to the filtering part 200 from a water source.

The controller 400 may drive the pump PP when pressure of water supplied to the filtering part 200 from the water source measured by the pressure sensor SP is lower than a preset pressure. Also, when the pressure of water supplied to the filtering part 200 from the water source measured by the pressure sensor SP is equal to or higher than the preset pressure, the controller 400 may not drive the pump PP or may reduce power of the pump PP according to pressure of water supplied to the filtering part 200, e.g., in inverse proportion to pressure of water supplied to the filtering part 200.

The preset pressure serving as a reference for driving the pump PP may be a filtration pressure or higher for supplying water to the RO filter 210 without driving the pump PP.

When pressure of water supplied to the filtering part 200 from the water source is lower than the preset pressure, the pump PP may be driven so that water may be supplied to the RO filter 210 by the pump PP. In addition, when pressure of water supplied from the water source to the filtering part 200 is higher than the preset pressure, the pump PP is not driven, so that water may be supplied to the RO filter 210 at pressure of water equal to or higher than the filtration pressure. Accordingly, since a driving time of the pump PP is reduced, transmission of vibrations to the RO filter 210 due to water hammering may be minimized. In addition, as described above, when pressure of water supplied to the filtering part 200 from the water source is equal to or higher than the preset pressure, for example, power of the pump PP may be reduced in inverse proportion to pressure of water supplied to the filtering part 200 from the water source. Accordingly, a magnitude of water hammering may be reduced or may be prevented from occurring, and thus, transmission of vibrations to the RO filter 210 due to water hammering may be minimized.

Meanwhile, the controller 400 may not drive the pump PP or reduce power of the pump PP for a preset time upon receiving a user instruction. For example, the controller 400 may not drive the pump PP or may reduce power of the pump PP at night. In addition, the controller 400 may not drive the pump PP or reduce power of the pump PP upon receiving a user instruction. In this case, the controller 400 may include an input unit (not shown) such as a touch screen for receiving a user instruction. Accordingly, a driving time of the pump PP may be reduced, a magnitude of water hammering may be reduced, or water hammering may not occur, thereby minimizing transmission of vibrations to the RO filter 210 due to water hammering. In addition, noise caused by water hammering at night during which quietness is required or in a specific case desired by the user may be minimized.

The controller 400 may also be electrically connected to the flow path switching valve VG, the purified water supply valve VP, the hot purified water supply valve VH, the cold purified water supply valve VC, the flushing valve VF, the supply valve VS, the shut-off valve VT, the iced water supply valve VI, and the flow sensor SF.

When the water purifier according to the present disclosure is used as described above, vibrations transmitted to the RO filter due to water hammering when water is supplied to the RO filter may be minimized and damage to the components of the water purifier such as the RO filter or the like due to vibrations due to water hammering or the like may be minimized.

The water purifier described according to exemplary embodiments of the present disclosure as described above is not limited in its application of configurations, but the entirety or a portion of the embodiments may selectively be combined to be configured to have various forms.

1. A water purifier comprising:
a filtering part including a reverse osmosis (RO) filter filtering water; and
a discharge part externally discharging purified water filtered by the filtering part,
wherein the filtering part further includes a pump provided in front of the RO filter and supplying water to the RO filter and a supply valve opened and closed so that water is supplied to the filtering part from a water source,
wherein the supply valve is provided between the pump and the RO filter.

2. The water purifier of claim 1, wherein the pump is directly connected to the water source.

3. (canceled)

4. A water purifier comprising:
a filtering part including a reverse osmosis (RO) filter filtering water; and
a discharge part externally discharging purified water filtered by the filtering part,
wherein the filtering part further includes a pump provided in front of the RO filter and supplying water to the RO filter and a pressure sensor measuring pressure of water supplied from a water source to the filtering part,
wherein the water purifier further includes a controller electrically connected to the pressure sensor and the pump,
wherein the controller drives the pump when pressure of water supplied from the water source to the filtering part, measured by the pressure sensor, is lower than a preset pressure, does not drive the pump when the pressure is equal to or higher than the preset pressure, and reduces power of the pump according to pressure of water supplied to the filtering part.

5. A water purifier comprising:
a filtering part including a reverse osmosis (RO) filter filtering water; and
a discharge part externally discharging purified water filtered by the filtering part,
wherein the filtering part further includes a pump provided in front of the RO filter and supplying water to the RO filter,
wherein the water purifier further includes: a controller electrically connected to the pump,
wherein the controller does not drive the pump or reduces power of the pump for a preset time or upon receiving a user instruction.

6. The water purifier of claim 1, wherein
the discharge part includes a purified water line in which purified water filtered by the filtering part flows, a discharge line connected to the outside, and a drain line connected to the discharge line, and
purified water is drained through the drain line for a predetermined period of time and subsequently discharged through the discharge line so as to be supplied to a user.

7. The water purifier of claim 6, wherein a flow path switching valve is provided at a portion where the discharge line and the drain line are connected, or a discharge valve is provided at the discharge line and a drain valve is provided on the drain line.

8. The water purifier of claim 7, wherein a purified water supply valve is provided in the purified water line.

9. The water purifier of claim 8, wherein a hot purified water line is connected to a portion of the purified water line before the purified water supply valve and to the discharge line, and a hot purified water supply valve and a water heater heating purified water to produce hot purified water are provided at the hot purified water line.

10. The water purifier of claim 9, wherein
hot purified water is drained through the drain line until a temperature of hot purified water discharged from the water heater reaches a predetermined temperature, and
when the temperature of the hot purified water discharged from the water heater reaches the predetermined temperature, hot purified water is externally discharged through the discharge line so as to be supplied to the user.

11. The water purifier of claim 8, wherein
a cold purified water line is connected to a portion of the purified water line before the purified water supply valve and to the discharge line, and
a cold purified water supply valve and a water cooler cooling purified water to produce cold purified water are provided at the cold purified water line.
